(19) United States
(12) Patent Application Publication
(10) Pub. No.: US 2014/0231523 A1
(43) Pub. Date: Aug. 21, 2014

(54) ELECTRONIC DEVICE CAPABLE OF RECOGNIZING OBJECT

(71) Applicant: Samsung Electronics Co., Ltd., Suwon-si (KR)

(72) Inventors: Viktor POLIANKO, Kiev (UA); Anton MYKHAILENKO, Kiev (UA); Ikhwan CHO, Suwon-si (KR); Kyusung CHO, Suwon-si (KR)

(73) Assignee: Samsung Electronics Co., Ltd., Suwon-si (KR)

(21) Appl. No.: 14/177,728

(22) Filed: Feb. 11, 2014

Related U.S. Application Data
(60) Provisional application No. 61/765,471, filed on Feb. 15, 2013.

(30) Foreign Application Priority Data
Nov. 22, 2013 (KR) 10-2013-0142645

(51) Int. Cl. G06K 7/14

(52) U.S. Cl. CPC G06K 7/1443; G06K 7/1417
USPC 235/462.09

(57) ABSTRACT

A method and a device, such as a portable terminal to recognize an object in an electronic device, and a method and a device, such as a portable terminal capable of detecting a barcode are provided. The method includes detecting finder pattern candidates, extracting contour information of the finder pattern candidates, determining one or more finder patterns among the finder pattern candidates based on at least a piece of the contour information, and detecting an alignment pattern based on at least a part of the one or more finder patterns and the contour information.

### CROSS-REFERENCE TO RELATED APPLICATION(S)

This application claims the benefit under 35 U.S.C. §119(e) of a U.S. Provisional application filed on Feb. 15, 2013 in the U.S. Patent and Trademark Office and assigned Ser. No. 61/765,471, and under 35 U.S.C. §119(a) of a Korean patent application filed on Nov. 22, 2013 in the Korean Intellectual Property Office and assigned Serial number 10-2013-0142645, the entire disclosure of which is hereby incorporated by reference.

### TECHNICAL FIELD

The present disclosure relates to an electronic device. More particularly, the present disclosure relates to an electronic device including a function of recognizing an object and a method of operating the same.

### BACKGROUND

Object recognition corresponds to recognizing an image, a character, a barcode, etc., by using a computer. In this way, electronic devices may include a technology of recognizing an object. In particular, recent electronic devices may recognize a square barcode. For example, a technology of recognizing a Quick Response (QR) code is being applied to a mobile terminal such as a smart phone, a tablet Personal Computer (PC), etc. Further, a technology of recognizing a barcode is being applied to various types of electronic devices or home appliances.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide electronic devices including a barcode recognition technology may recognize a barcode by using a camera. When the camera obliquely photographs the barcode, a part of the barcode which is far away from the camera may be photographed as being small, and a part of the barcode which is relatively close to the camera may be photographed as being large. However, the barcode recognition technology according to the related art does not consider such a pose or position of the camera. Thus, data may not be extracted from the barcode, or the extracted data has an error(s).

At least some embodiments of the present disclosure may present a method of solving the above-mentioned points in addition to other uses. In accordance with various embodiments of the present disclosure, information related to the pose of the camera may be extracted. Accordingly, it is possible to prevent problems that data cannot be extracted or the extracted data has an error(s). Further, in accordance with various embodiments of the present disclosure, since the pose of the camera is considered, the barcode may be exactly detected. Further, when it is determined that recognition of the barcode is difficult since the camera and the barcode is disposed obliquely, this content may be fed back to a user. The user who has received this feedback may enable the barcode to be exactly recognized by adjusting the pose of the camera. Here, the pose may indicate a photographing angle, a photographing state, etc. in the present disclosure.

Various embodiments of the present disclosure relate to a method and a device (portable terminal) for recognizing an object in an electronic device, and more particularly, to a method and a device (portable terminal) capable of detecting a barcode among objects. Although the following various embodiments mainly describe a portable terminal or a mobile device, it is obvious to those skilled in the art that the present disclosure may be easily used in other various electronic devices capable of recognizing an object.

In accordance with an aspect of the present disclosure, a method of recognizing an object is provided. The method includes detecting finder pattern candidates, extracting contour information of the finder pattern candidates, determining one or more finder patterns of a barcode in a digital image among the finder pattern candidates based on at least a piece of the contour information, and detecting an alignment pattern based on at least a part of the one or more finder patterns and the contour information.

In accordance with another aspect of the present disclosure, an electronic device is provided. The electronic device includes a memory that stores a digital image, and a processor that processes the digital image, wherein the processor detects finder pattern candidates, extracts contour information of the finder pattern candidates, determines one or more finder patterns of a barcode in the digital image among the finder pattern candidates based on at least a piece of the contour information, and detects an alignment pattern based on at least a part of the one or more finder patterns and the contour information.

In accordance with a method and an electronic device for recognizing an object according to the present disclosure, the present disclosure may detect information related to a pose of a camera from a barcode. Accordingly, it is possible to prevent problems that data cannot be extracted or the extracted data has an error(s).

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other objects, features, and advantages of certain embodiments of the present disclosure will be more apparent from the following description in conjunction with the accompanying drawings, in which:

FIG. 1 is a block diagram illustrating a system for processing an object according to an embodiment of the present disclosure;

FIG. 2 is a block diagram illustrating a main unit of the system of FIG. 1 according to an embodiment of the present disclosure;

FIG. 3 illustrates a configuration of a terminal to which an object tracking function is applied according to the present disclosure;

FIG. 4 illustrates an example of a platform to which an object tracking function is applied according to the present disclosure;

FIG. 5 is an overall flowchart illustrating a method of detecting a barcode according to an embodiment of the present disclosure;

FIG. 6 is a flowchart illustrating a method of detecting a candidate of a finder pattern according to an embodiment of the present disclosure;

FIG. 7 illustrates an example of a Quick Response (QR) code according to an embodiment of the present disclosure;

FIG. 8 illustrates a binarized image of a candidate which is detected during a scanning process according to an embodiment of the present disclosure;

FIG. 9 is a flowchart illustrating a method of determining a finder pattern among the detected candidates according to an embodiment of the present disclosure;

FIG. 10 illustrates an example of a contour of a finder pattern according to an embodiment of the present disclosure;

FIG. 11 is a flowchart illustrating a method of determining a finder pattern among detected candidates according to another embodiment of the present disclosure;

FIG. 12 is a view for describing an example of a process of calculating a version of a barcode based on a finder pattern according to an embodiment of the present disclosure; and

FIG. 13 is a view for describing an example of a process of detecting an alignment pattern based on a finder pattern according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, an electronic device corresponds to a device including a camera, and may include, for example, a smart phone, a tablet PC, a notebook PC, a digital camera, a computer monitor, a Personal Digital Assistant (PDA), an electronic notepad, a desktop PC, a Portable Multimedia Player (PMP), a media player (e.g. a MP3 player), a sound equipment, a watch, a gaming terminal, a home appliance (e.g. a refrigerator, a television, and a washing machine) having a touch screen, etc.

Hereinafter, a method and an electronic device for detecting a barcode according to the present disclosure will be described in detail. Terms or words used below should not be interpreted using typical or dictionary limited meanings, and should be construed as meanings and concepts conforming to the technical spirit of the present disclosure. Thus, since the following descriptions and accompanying drawings are just drawn to the various embodiments of the present disclosure and do not represent all the technical spirits of the present disclosure, various equivalents and variations which can substitute for these descriptions and drawings may be made at the time of filing of the application of the present disclosure. Further, some components in the accompanying drawings may be exaggerated or schematically illustrated or omitted, and the size of each component does not completely reflect the actual size of each component. Thus, the present disclosure is not limited by the relative size or space drawn in the accompanying drawings. When it is determined that a detailed description of well-known functions or configurations related to the present disclosure causes confusion in the subject matter of the present disclosure, the description will be omitted.

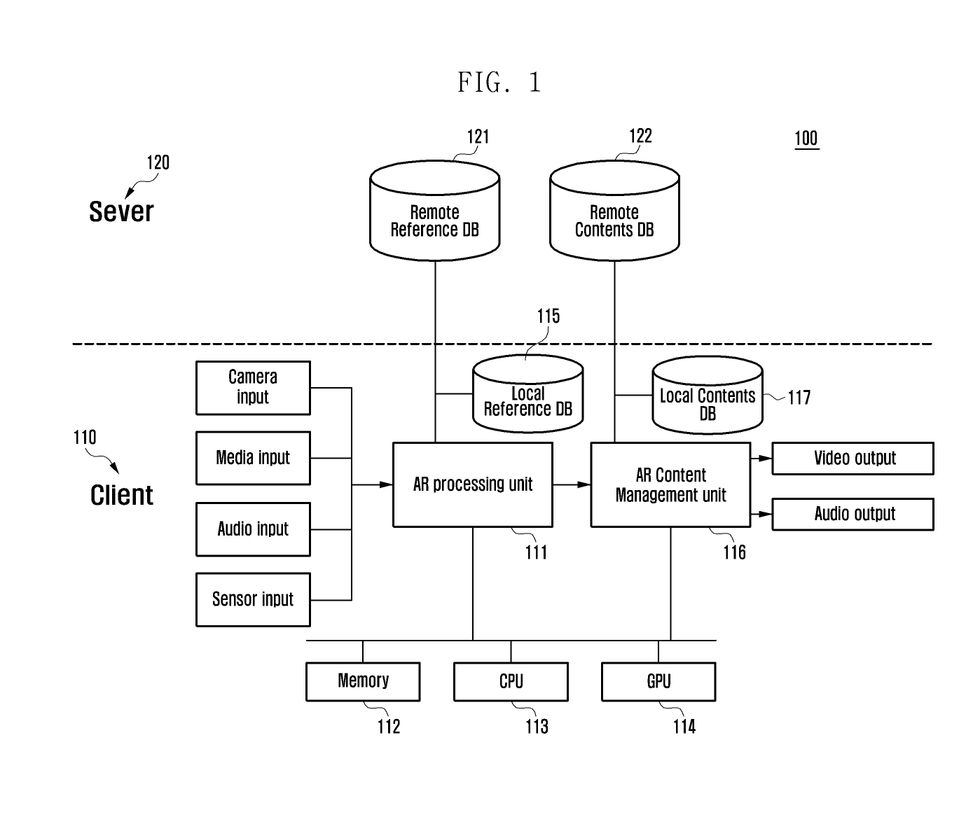

FIG. 1 is a block diagram illustrating a system for processing an object according to an embodiment of the present disclosure.

Referring to FIG. 1, a system 100 for processing an object may include a client 110, a server 120, and communications networks.

In the system 100 for processing an object, including such a configuration, according to the present disclosure, the above-described object tracking function is mounted to the client 110, and is supported based on the mounted state. The system 100 for processing an object according to the present disclosure may form a communication channel between the server 120 and the client 110 through a communications network by using a communication unit of the client 110. Accordingly, information used in a process of supporting the object tracking function may be supplied to the client 110 through the server 120. Further, in the present disclosure, the client 110 may receive data stored in the server 120 from the server 120, store the data, and support the object tracking function based on the stored data.

In the system 100 for processing an object, the client 110 may be implemented by any one of the above-mentioned electronic devices, and perform a connection to the server 120 through the communications network. Further, the client 110 may provide acquired image information to the server 120. In particular, the client 110 may provide acquired image information to the server 120 in a real-time manner. Then, the server 120 may calculate phase correlation for the object tracking based on the received image information and provide the calculated value to the client 110. The client 110 may omit calculation for the object tracking in image information based on the value provided by the server 120 and support data processing for easier object tracking. Meanwhile, the client 110 may receive remote reference data and contents data provided by the server 120. Further, the client 110 may perform recognition of image information and object localization by using the remote reference data. Further, the client 110 may perform a control to apply the content data to Augmented Reality (AR).

In the system 100 for processing an object, the client 110 may be applied to the above-mentioned electronic device, and include an AR processing unit 111 which may be a main unit. The AR processing unit 111 may receive camera input data, media input data, audio input data, and sensor input data from various input units, for example, a camera, a media unit, an audio unit, and a sensor unit, respectively. The sensor input data may include input data of at least one of an accelerometer, a gyroscope, a magnetic sensor, a temperature sensor, and a gravity sensor. The AR processing unit 111 may use a memory 112, a Central Processing Unit (CPU) 113, and a Graphic Processing Unit (GPU) 114, for processing the input data. Further, the AR processing unit 111 may use a reference Database (DB) in order to identify a target, e.g. a Quick Response (QR) code and recognize the target (e.g. detect the target (for example, a QR code) among objects). Such a reference DB may include a local reference DB 115 provided in the client 110 and a remote reference DB 121 provided in the server 120. Output data output from the object processing unit 111 may include, for example, identification information and object localization information. Location measurement information may be used in order to determine a 2 Dimensional (2D) pose and/or a 3 Dimensional (3D) pose of a target. The identification information may be utilized in order to determine an object. An AR content management unit 116 may use the output data of the object processing unit 111 and the contents stored in remote/local content DB 122 and 117 in order to organize final video/audio output data.

In the system 100 for processing an object, the server 120 supports connection of the client 110. Further, the server 120 supports the object tracking function and the augmented reality service function according to a request of the client 110. The server 120 may store the remote reference DB 121 in order to support the object tracking function. Further, the server 120 may store the remote contents DB 122 applied to the augmented reality in order to support the augmented reality service function. The server 120 may perform calculation of at least one of a recognition process, an object localization process, and an object tracking process of specific image information. Further, the server 120 may provide the result performed at each of the processes to the client 110 according to a request of the client 110.

In the system 100 of processing an object, the communications network may be disposed between the client 110 and the server 120. The communications network may form a communication channel between the two components. The communications network may be formed by mobile communications network devices when the client 110 supports a mobile communication function. Further, the communications network may be formed by devices for supporting an internet network when the server 120 connects communication devices through the internet network. Further, the communications network may further include a network device for transferring data between heterogeneous networks. Thus, the communications network according to the present disclosure is not limited to a specific communication scheme or a communication unit, and should be understood as a device to which various devices and methods for transmitting and receiving data between the client 110 and the server 120 are applied.

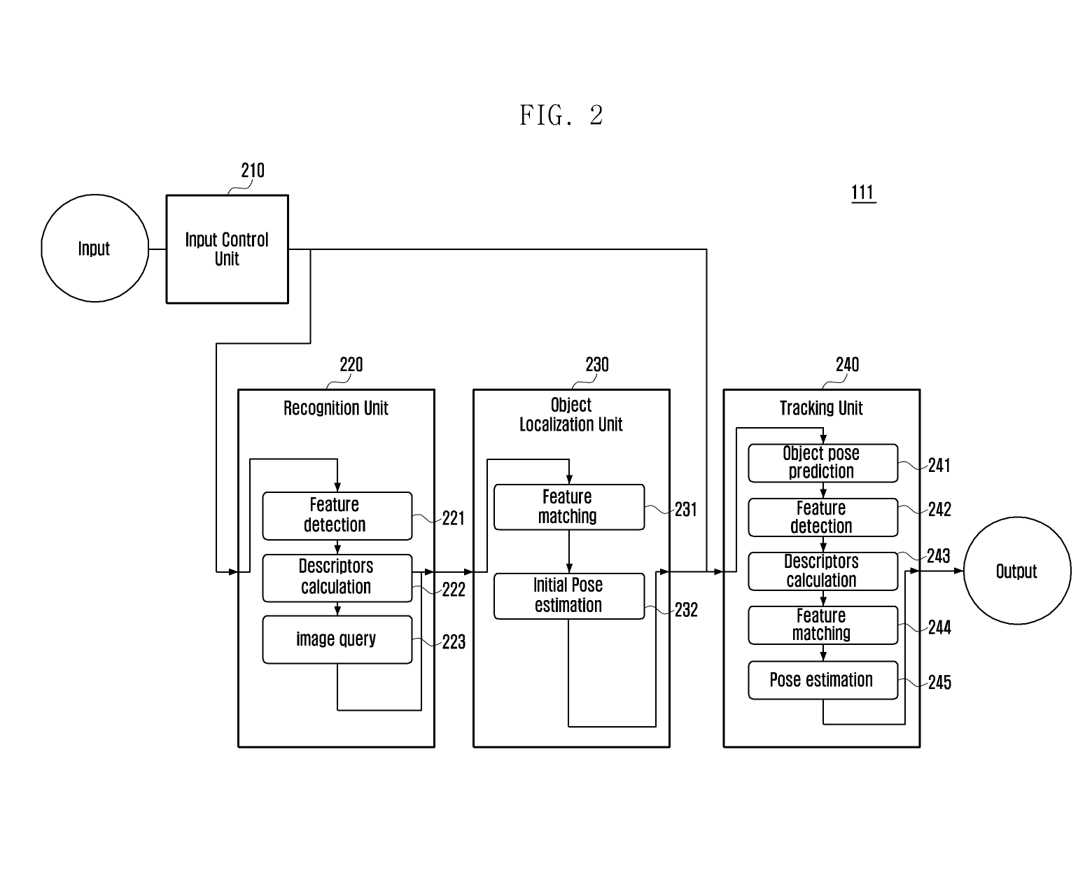

FIG. 2 is a block diagram illustrating a main unit of the system of FIG. 1 according to an embodiment of the present disclosure.

Referring to FIG. 2, the AR processing unit 111 may include an input control unit 210, a recognition unit 220, an object localization unit 230, and a tracking unit 240.

The input control unit 210 may classify input data provided to the main unit 111. Further, the input control unit 210 may determine a delivery route of the input data according to a current functional performance state of the main unit 111. For example, the input control unit 210 may provide initial image information to the recognition unit 220 when acquiring the corresponding image information. The image information may be acquired from a camera connected to the main unit 111 or a camera disposed in a terminal including the main unit 111.

The input control unit 210 may directly transfer the image information to the tracking unit 240 when the recognition unit 220 completes an image recognition process and the object localization unit 230 completes the object localization process. Further, the input control unit 210 may simultaneously transfer the image information to the recognition unit 220 and the tracking unit 240. Accordingly, the recognition process and the object tracking process of the image information may be performed in parallel.

The input control unit 210 performs a control not to provide the image information to the recognition unit 220 when the tracking unit 240 is performing the object tracking function. Further, the input control unit 210 may support to provide the image information to the recognition unit 220 again when the tracking unit 240 fails to perform the object tracking. Further, the input control unit 210 may provide other input information, e.g. audio information, sensor information, etc. to the tracking unit 240 when the AR contents are applied to objects being tracked.

The recognition unit 220 may perform the recognition process of image information when receiving the image information from the input control unit 210. That is, the recognition unit 220 may perform feature detection 221, descriptor calculation 222, and an image query process 223 from the received image information.

The feature detection 221 may be a process of detecting feature points from an image. The feature detection 221 may include a binarization process. That is, when the binarization process is performed, a color image is converted into a black-and-white image. Further, the feature detection 221 according to the present disclosure may include a barcode detection process.

A descriptor may be information which defines inherent characteristics of a corresponding image calculated based on the detected characteristic information. The descriptor may be defined by at least one of location of the feature points, arrangement between the feature points, and inherent characteristic of the feature points, of each predetermined part of the image information. That is, the descriptor may be a value obtained by simplifying an inherent characteristic of a predetermined point of the image information. Thus, at least one descriptor may be extracted from a piece of image information.

When the descriptor calculation 222 is completed, the recognition unit 220 performs comparison of the descriptor with reference data through the image query process 223. That is, the recognition unit 220 identifies that there is reference data having a descriptor equal to the calculated descriptor or a descriptor similar to the calculated descriptor within a predetermined error range. The reference data may be provided from an internal memory provided for an operation of the main unit 111. Further, the reference data may be provided from an external storage device, e.g. a separate server, in order to operate the main unit 111. The reference data may be image information previously stored for a specific image. For example, a face recognition process may require an external reference face database in order to recognize certified faces, and may include a process of identifying a difference between faces different from each other. Meanwhile, the QR code needs not to be dynamically updated in common cases. Further, a specific rule is needed for recognizing the QR code from a database. Thus, the QR code may generally have internal reference data. The recognition unit 220 may simplify a calculation for the image recognition process using the reference data. Further, the recognition unit 220 may perform target object identification using the reference data.

The object localization unit 230 localizes various objects constituting image information. Such an object localization unit 230 performs a feature matching 231 and an initial pose estimation 232. That is, the object localization unit 230 extracts feature points of objects localized in image information. Further, the object localization unit 230 matches the feature points of the specific objects with a predetermined object of the reference data. At this time, the object localization unit 230 may newly update matching information when there is no matching information of the feature points. When feature matching for the object is completed, the object localization unit 230 performs the initial pose estimation of at least one object included in the image information. When the main unit 111 activates the object tracking function, the object localization unit 230 provides information related to the object, including at least one of the matching information and the initial angle information, to the tracking unit 240.

The tracking unit 240 receives the initial pose estimation of the recognized target objects from the object localization unit 230. Further, the tracking unit 240 may continuously maintain tracking through angle calculation of the target object. The tracking unit 240 may basically output the recognition information and the object localization information included in the object angle. Particularly, the tracking unit 240 according to the present disclosure may proceed to track objects by using key frames. At this time, the tracking unit 240 may support key frame selection, key frame management, and key frame operation when it fails in tracking the object. As illustrated in FIG. 2, the tracking unit 240 may include an object pose prediction unit 241, a feature detection unit 242, a descriptor calculation unit 243, a feature matching unit 244 and a pose estimation unit 245.

The object pose prediction unit 241 may predict a pose of at least one object included in image information. The object pose prediction unit 241 may receive an initial pose estimation value of at least one object included in the image information from the object localization unit 230. Accordingly, the object pose prediction unit 241 may predict the pose of the object according to movements of objects included in the image information, based on the initial pose estimation value of the objects. That is, the object pose prediction unit 241 may predict in which direction, position, and/or pose at least one object included in the image information moves, based on the initial pose estimation value.

More specifically, the object pose prediction unit 241 compares previously acquired image information with currently acquired image information, so as to calculate a degree of the movement of the whole image information, that is, at least one of a movement distance, a movement direction, and a movement pose. Further, the object pose prediction unit 241 may predict a movement of at least one object included in the image information, based on the calculated movement degree. For example, the object pose prediction unit 241 may perform phase correlation between the previous frame and the current frame. At this time, the object pose prediction unit 241 may perform the phase correlation by applying a Fast Fourier Transform (FFT) algorithm. Further, the object pose prediction unit 241 may predict the movement pose and movement distance of the object by applying various existing algorithms (for example, Pose from Orthography and Scaling with Iteration (POSIT)). The object pose prediction may be performed in real time.

When the prediction of the object movement is completed by the object pose prediction unit 241, the feature detection unit 242 may detect features of the currently acquired image information or features of the object. The same process as a feature detection performed by the recognition unit 220 may be applied to the detection of the features of the image information performed by the feature detection unit 242. Alternatively, the feature detection process performed by the feature detection unit 242 may be simpler than the feature detection process performed by the recognition unit 220. That is, the feature detection unit 242 may extract a relatively smaller number of features in comparison with the feature detection performed by the recognition unit 220, or may extract the features in a relatively narrower area in comparison with the feature detection performed by the recognition unit 220, in order to support the tracking of the movement of the object. For example, the feature detection unit 242 of the tracking unit 240 may detect only features of a particular object within a predetermined range area. At this time, the predetermined range area may be set in various levels.

Meanwhile, the feature detection unit 242 may select at least one of the previously stored key frames. Further, the feature detection unit 242 may calculate a parameter for matching the current image information and key frames. For example, the feature detection unit 242 may perform integral image processing to record feature location information in the image information. The integral image processing may be processing of defining a location value of each of the features from a reference point of the image information. Particularly, the image processing may define a location value of a particular feature included in the image information according to each of accumulated areas based on a particular edge point which can be defined as a predetermined point, for example, (0, 0) in a (x, y) coordinate. Accordingly, the calculation of the location value of the feature at the particular point may be performed by subtracting a location value of accumulated areas which do not include the corresponding point from the location value of the accumulated areas including the corresponding point. Meanwhile, the feature detection unit 242 may define feature location information in the image information by relation with other features adjacent to the feature.

The descriptor calculation unit 243 may calculate a descriptor based on a result of the feature detection. The descriptor calculation unit 243 may calculate the descriptor based on the features detected by the feature detection unit 242 of the tracking unit 240. The descriptor may be defined by predetermined areas or a number of areas arranged on the image information or features of areas included in at least one object. For example, the descriptor calculation unit 243 applied to the present disclosure may use a chain type pyramid Binary Robust Independent Elementary Feature (BRIEF) descriptor (hereinafter referred to as a chain type BRIEF descriptor or a descriptor).

The chain type BRIEF descriptor may rotate (x, y) pairs of features in the image information by the pre-calculated feature pose in order to acquire robustness of the rotation. Further, to provide robustness of blur processing for noise removal and high performance, the chain type BRIEF descriptor may use respective areas around pixels instead of smoothed intensities of the pixels. In addition, the chain type BRIEF descriptor may select a size of one side of a quadrangle in proportion to pre-calculated feature scale and re-calculate a set of (x, y) pairs in accordance with the scale to provide robustness of the scale. The descriptor calculation unit 243 may provide a corresponding result to the feature matching unit 244 when the descriptor calculation is completed.

The feature matching unit 244 may perform the feature matching based on the chain type BRIEF descriptor calculated by the descriptor calculation unit 243. That is, the feature matching unit 244 may search for a descriptor similar to the chain type BRIEF descriptor calculated from the key frame in the current image information and compare the chain type BRIEF descriptor and the found descriptor, so as to perform the matching between the descriptors. When a result of the comparison between the key frame and the current image information is smaller than a predefined value, for example, when the similarity is smaller than a predetermined value, the feature matching unit 244 may define the current image information as a new key frame candidate. Further, the feature matching unit 244 may make support such that the new key frame candidate is registered in the key frames according to a design scheme. At this time, the feature matching unit 244 may remove a previously registered key frame and register the new key frame candidate as the key frame. Alternatively, the feature matching unit 244 may make support such that the new key frame is registered without the removal of the previously registered key frame. Meanwhile, the feature matching unit 244 may perform matching between the current image information and features of at least some areas included in the key frame. Such a case corresponds to a case where the descriptor includes only one feature.

The pose estimation unit 245 may estimate degrees of a pose and a location generated by the object movement in the image information through the descriptor matching between the key frame and the current image information. That is, the pose estimation unit 245 may detect whether the movements of the objects included in the image information match predicted information. Here, the pose estimation unit 245 may identify a changed scale and direction of the object according to the object movement and perform a correction of the object according to the change. The pose estimation unit 245 collects a direction change and a scale change which should be expressed by the actual object movement in a state where the prediction matches the actual object movement.

Further, the pose estimation unit 245 may control to apply contents according to the direction change and the scale change to displaying of augmented reality contents to be applied to the corresponding object. That is, when the scale is reduced according to the movement of the object, the pose estimation unit 245 may change a size of the augmented reality contents to be displayed in accordance with the scale change and display the augmented reality contents of the changed size. Further, when the direction is changed according to the movement of the object, the pose estimation unit 245 may control a direction of the augmented reality contents to be displayed in accordance with the direction change of the corresponding actual object and display the augmented reality contents of the changed direction.

The tracking unit 240 may perform relocalization when failing in tracking the object. Through the relocalization, the tracking unit 240 may rapidly make up for the object tracking failure. When the object which is being tracked is not detected from the current image information, the tracking unit 240 may re-perform the object tracking based on at least one key frame among the key frames used for tracking the object in the corresponding image information. That is, the tracking unit 240 may extract objects from the currently collected image information and compare a descriptor defining features of the extracted objects with descriptors of the objects in the key frames. Further, the tracking unit 240 may select key frames having most similar descriptors and support the re-performance of the object tracking. The tracking unit 240 may compare similarity between the current image information and the key frame based on a descriptor including at least one feature. As a result, the tracking unit 240 may compare the current image information and at least some features of the key frame and select a key frame which is the most similar to the current image information based on the comparison. Further, the tracking unit 240 may make support such that objects included in the selected key frame are tracked for the current image information. To this end, the tracking unit 240 may include a separate component (for example, a relocalization unit) performing the localization.

The tracking unit 240 may preferentially perform a comparison between a key frame which is used just before the object tracking failure and the current image information. Further, when the similarity between the descriptors is equal to or larger than a predetermined value as a result of the corresponding comparison, the tracking unit 240 may support the performance of the object tracking function based on the corresponding key frame without selection and comparison of other key frames. Alternatively, the tracking unit 240 may register previous image information to which the key frame has been applied just before the current image information collection as a new key frame, compare descriptors of the newly registered key frame and the current image information, and make a request for performing the tracking function according to a result of the comparison.

Through such a process, the tracking unit 240 according to the present disclosure may recover the object tracking failure with a higher probability through the relocalization without re-performance of the object recognition and localization processes when the object tracking is failed. As a result, the tracking unit 240 according to the present disclosure may support more rapid object tracking performance by reducing time and calculation spent for the object recognition and localization processes through the relocalization.

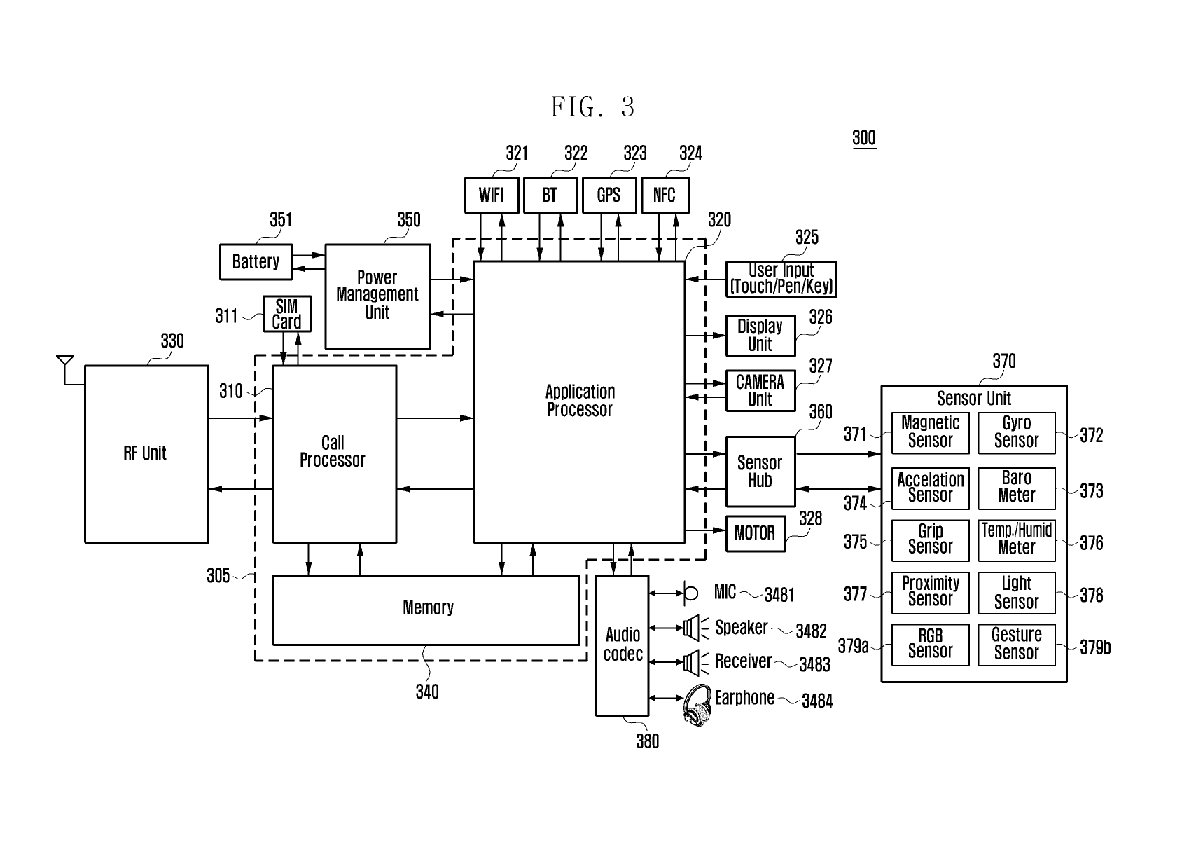

FIG. 3 illustrates a configuration of a terminal to which an object tracking function is applied according to the present disclosure. That is, a terminal 300 illustrated in FIG. 3 may be an example of an electronic device to which the above-described main unit is mounted.

Referring to FIG. 3, the terminal 300 includes a controller 305 controlling an overall operation of the terminal 300 and a signal flow between internal components of the terminal 300, processing data, and supplying electric power from a battery 351 to the internal components. The controller 305 may include a call processor 310, an application processor 320, and a memory 340.

The call processor 310 may transmit/receive a signal to/from a Radio Frequency (RF) unit 330 and may transmit/receive a signal to/from a memory 340 and a Subscriber Identification Module (SIM) card 311. Further, the call processor 310 may support a working processes needing access to the RF unit 330, the memory 340, and the SIM card 311 among processes performed by the application processor 320 in communication with the application processor 320.

The application processor 320 may operate as the above-mentioned AR processing unit 111. Further, the application processor 320 may include one or more Central Processing Units (CPUs). Further, the application processor 320 may further include one or more Graphic Processing Units (GPUs).

The application processor 320 receives electric power from an electric power management unit 350 to which the battery 351 is connected. The application processor 320 transmits/receives a signal to/from various communication units, e.g. a Wi-Fi unit 321, a Bluetooth (BT) unit 322, a GPS unit 323, a Near Field Communication unit (NFC) unit 324, etc. in addition to the RF unit 330, and supports a function performed by each unit.

The application processor 320 may be connected to a user input unit 325 including a touch panel and a key input unit. Here, the touch panel may be installed at a screen of a display unit 326. The touch panel may generate a touch event in response to a gesture of a touch input device (for example, a finger, a pen, etc.) for the screen and convert the touch event from an analog state to a digital state to transfer the converted touch event to the application processor 320. The key input unit may include a touch key. The touch key may be implemented by a capacitive scheme, a resistive scheme, or the like in order to detect a user's touch. The touch key may generate an event in response to a user's touch and transfer the event to the application processor 320. The key input unit may include a key (for example, a dome key) of other schemes in addition to the touch scheme.

The application processor 320 may transmit/receive a signal to/from the memory 340. Here, the memory 340 may include a main memory unit and a secondary memory unit. The secondary memory unit may store a booting program, at least one operating system, and applications. The main memory unit may store various programs, e.g. a booting program, an operating system, and an application, loaded from the secondary memory unit. When electric power of the battery 351 is supplied to the application processor 320, the booting program is first loaded to the main memory unit. Such a booting program loads the operating system to the main memory unit. The operating system loads the applications to the main memory unit. The application processor 320 may access such a program, to decrypt a command of the program, so as to execute a function (e.g. the object recognition, the object localization, and the object tracking) according to the decryption result.

The application processor 320 may be connected to the display unit 326, a camera 327, a vibration motor 328, an audio processing unit 380, etc.

Here, the display unit 326 displays data on a screen under the control of the controller 305, especially, the application processor 320. That is, when the controller 305 processes (e.g. decodes) the data and stores the processed data in a buffer, the display unit 326 converts the data stored in the buffer into an analog signal and displays the converted data on the screen. When electric power is supplied to the display unit 326, the display unit 326 displays a locking image on the screen. When unlocking information is detected while displaying the locking image, the controller 305 unlocks the screen. The display unit 326 displays a home image instead of the locking image under the control of the controller 305. The home image includes a background image (e.g. a picture set by a user) and various icons displayed thereon. Here, the icons indicate applications or contents (e.g. a picture file, a video file, a record file, a document, a message, etc.), respectively. When one of the icons, e.g. an icon of an object tracking application, is touched by the touch input device, the controller 305 may drive the camera 327 and execute the object tracking application by using an image received from the camera 327. The display unit 326 may receive an image (e.g. a preview image and object tracking information) obtained by executing the object tracking application from the controller 305, and convert the image into an analog signal to output the converted image.

The camera 327 performs a function of photographing a subject and outputting the photographed subject to the application processor 320. The camera 327 may include a lens for collecting light, an image sensor for converting the light into an electric signal, and an Image Signal Processor (ISP) for processing the electric signal input from the image sensor into a frame (raw data). The ISP may resize a frame which is in a buffer (known as a queue) of the ISP on standby into a preview image. In general, the ISP downsizes the frame to fit with a size of the screen. Further, the ISP outputs the preview image to the application processor 320. Then, the application processor 320 controls the display unit 326 to display the preview image on the screen. The application processor 320 may perform such resizing. For example, the frame may be transferred from the camera 327 to the buffer of the application processor 320, and the application processor 320 may process the frame into the preview image to output the preview image to the display unit 326.

The audio processing unit 380 may include a microphone 3481, a speaker 3482, a receiver 3483, an earphone connection device 3484, etc. The application processor 320 may be connected to a sensor hub 360. The sensor hub 360 may be connected to a sensor unit 370 including various sensors. The sensor unit 370 may include at least one of a magnetic sensor 371, a gyro sensor 372, a barometer 373, an acceleration sensor 374, a grip sensor 375, a temperature/humidity sensor 376, a proximity sensor 377, a light sensor 378, an RGB sensor 379a, and a gesture sensor 379b. However, it is noted that the sensor unit 370 may include more or less sensors.

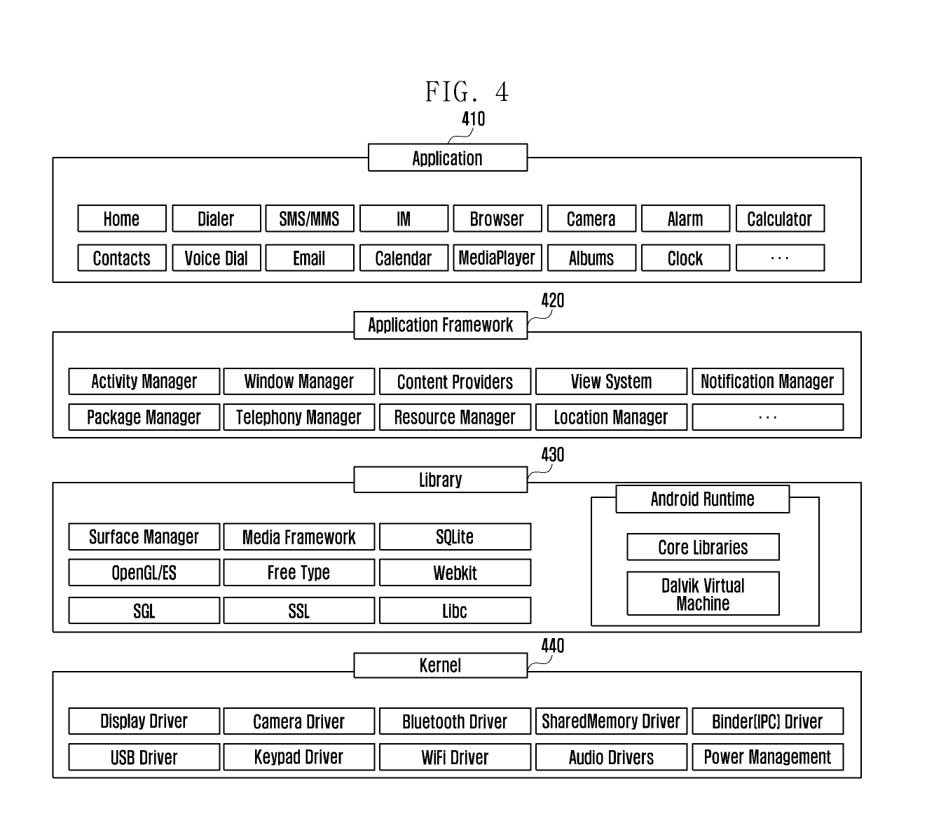

FIG. 4 illustrates an example of a platform to which an object tracking function is applied according to the present disclosure.

Referring to FIG. 4, a platform to which the object tracking function according to the present disclosure is applied may mainly include an application layer 410, an application framework layer 420, a library layer 430, and a kernel layer 440.

The kernel layer 440 may be configured by, for example, a Linux kernel. The kernel layer 440 may include a display driver, a camera driver, a BT driver, a shared memory driver, a binder driver, a USB driver, a keypad driver, a Wi-Fi driver, an audio driver, and a power management unit.

The library layer 430 includes a surface manager, a media framework, SQLite, OpenGL/ES, Free Type, Webkit, SGL, SSL, Libc, etc. The library layer 430 may include a configuration of an Android runtime. The Android runtime may include a core library and Dalvik Virtual Machine. The Dalvik Virtual Machine may support a widget function, a function requiring real-time execution, and a function requiring cyclic execution according to a preset schedule, of a terminal supporting the object tracking function, but is not limited thereto.

The application framework layer 420 may include an activity manager, a window manager, a content provider, a view system, a notification manager, a package manager, a telephony manager, a resource manager, a location manager, etc. The application layer 410 may include a home application (hereinafter, referred to as “App”), a dialer App, a SMS/MMS App, an Instant Messenger (IM) App, a camera App, an alarm App, a calculator App, a contents App, a voice dial App, an e-mail App, a calendar App, a media-player App, an albums App, a clock App, etc.

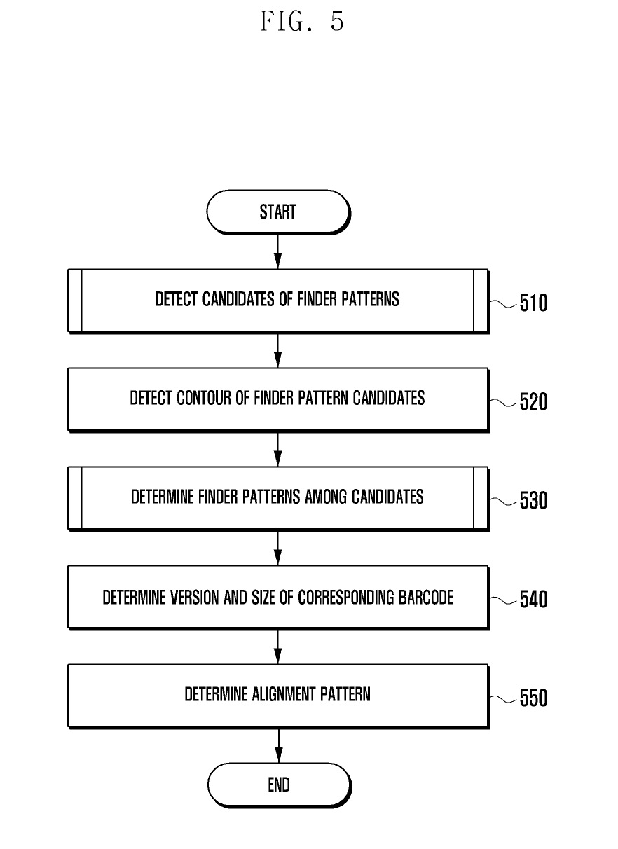

Hereinafter, especially, barcode detection among the object tracking function according to the present disclosure will be described with reference to FIGS. 5 to 13.

FIG. 5 is an overall flowchart illustrating a method of detecting a barcode according to an embodiment of the present disclosure.

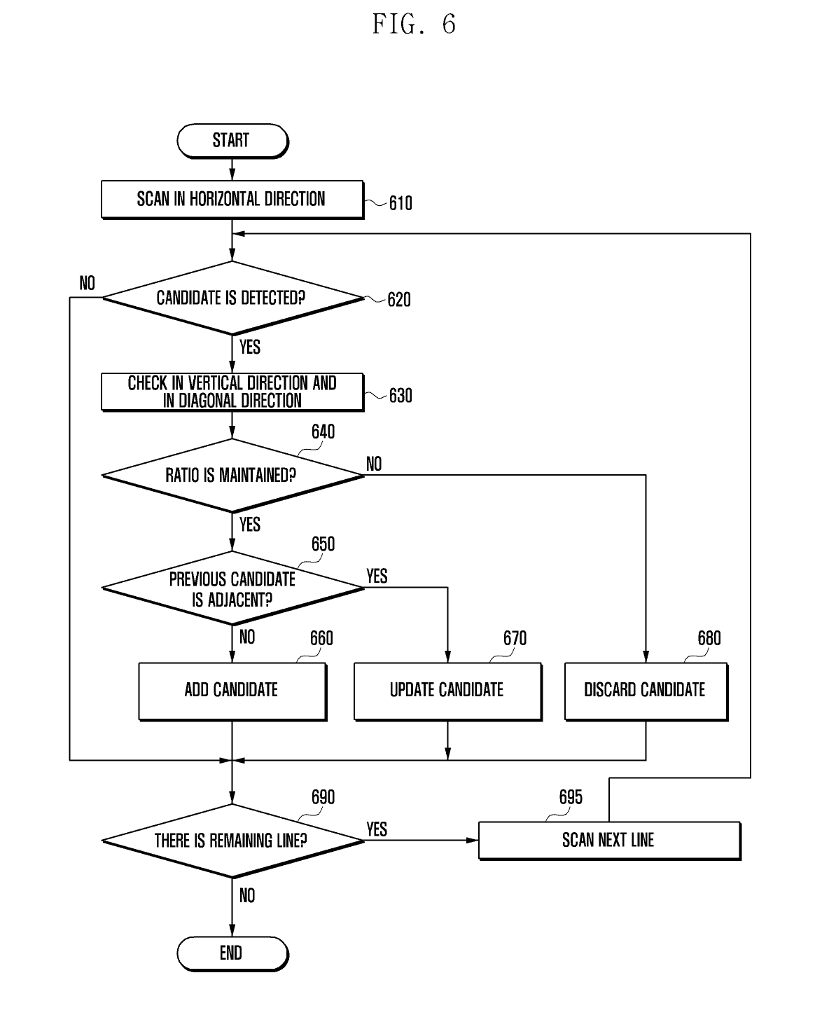

Referring to FIGS. 3 and 5, in operation 510, the controller 305 according to the present disclosure, especially, the application processor 320 may receive an image from the camera 327 and detect a candidate, which may become a finder pattern, from the image. Here, the finder pattern is a symbol for finding a location of the corresponding barcode. For example, when QR code has a square shape, finder patterns are located at three corners among four corners. Thus, when such finder patterns are searched for, a region of the corresponding barcode may be determined, and data may be extracted from the determined region. Operation 510, i.e. an example of a method of detecting a candidate, will be described in detail with reference to FIGS. 6 to 8.

Next, in operation 520, the controller 305 detects contours of the candidates. Here, when a size (e.g. values indicating a width, a height, an area, etc.) of the contour is less than a first value selected by the controller 305, the corresponding candidate may be discarded from a list. Further, when the size of the contour is greater than a second value selected by the controller 305, the corresponding candidate may be discarded from the list.

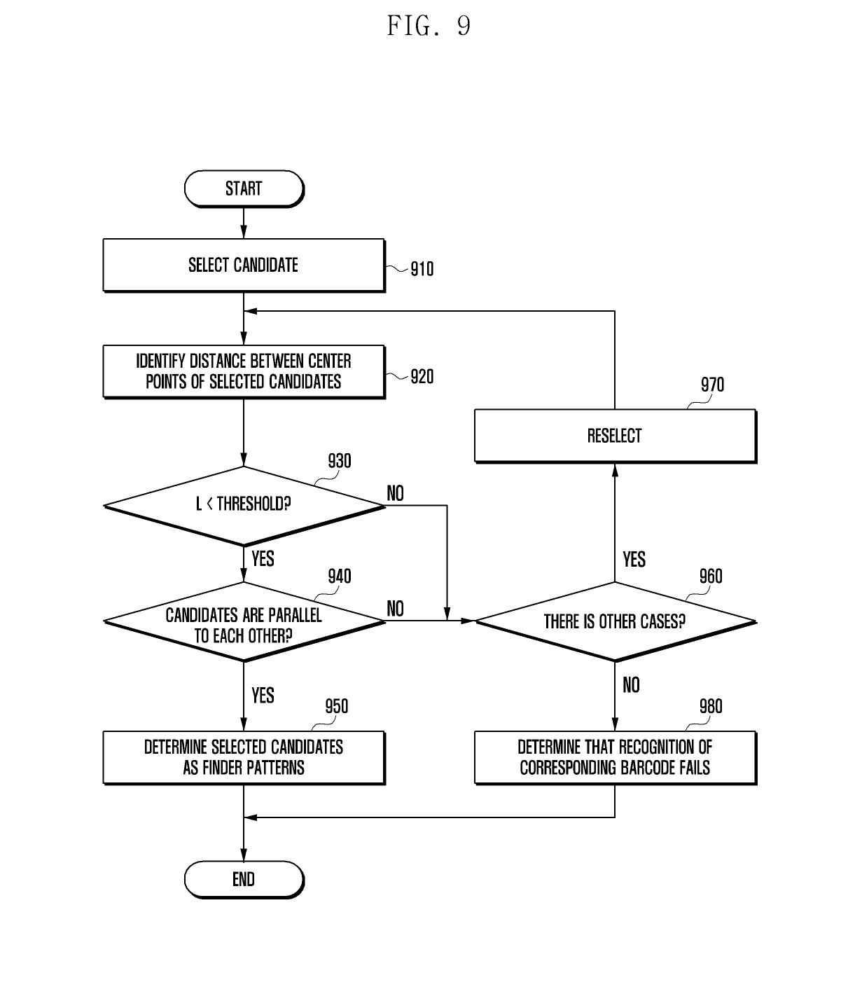

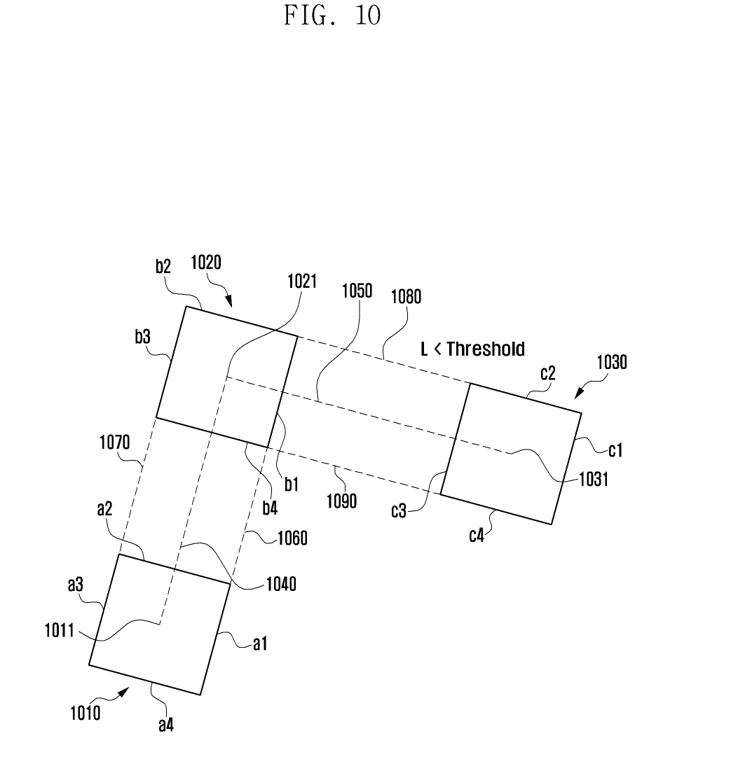

In operation 530, the controller 305 determines finder patterns among the candidates based on the detected contours. An example of a method of determining a finder pattern will be described in detail with reference to FIGS. 9 and 10.

In operation 540, the controller 305 determines a version and a size of the corresponding barcode by using the finder patterns. The controller 305 may object-localize the corresponding barcode at the image based on size information and location information (e.g. vertex coordinates) of the determined finder patterns. The corresponding barcode object-localized from the image (i.e. separated from the image) may be warped in order to be restored, and data may be extracted from the warped barcode.

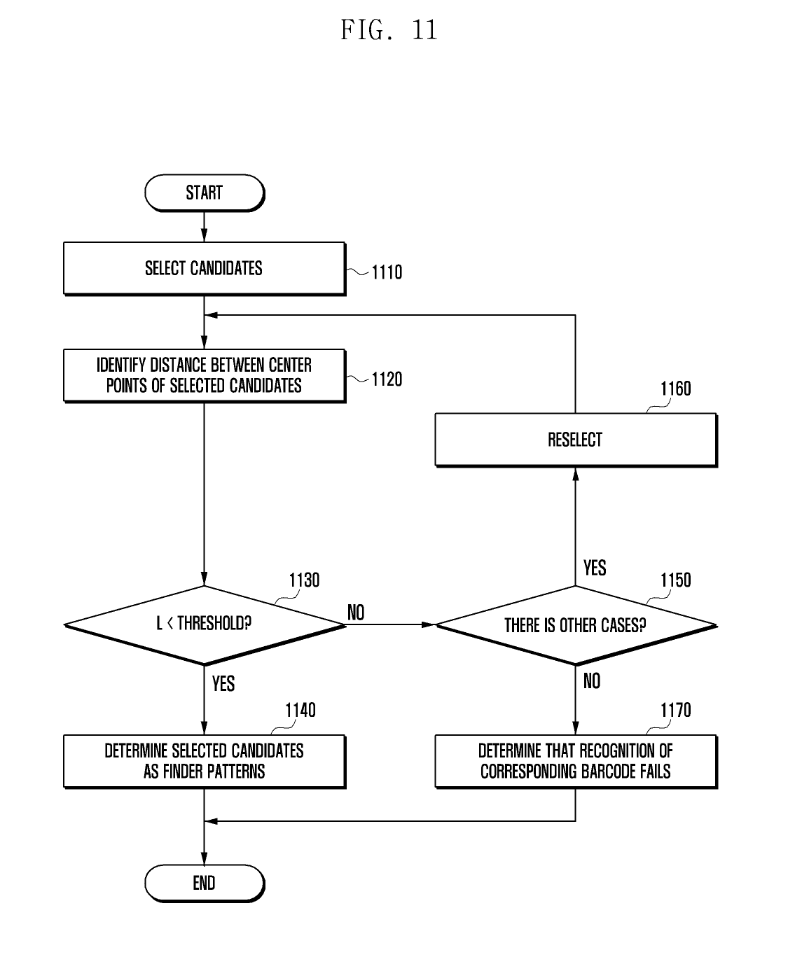

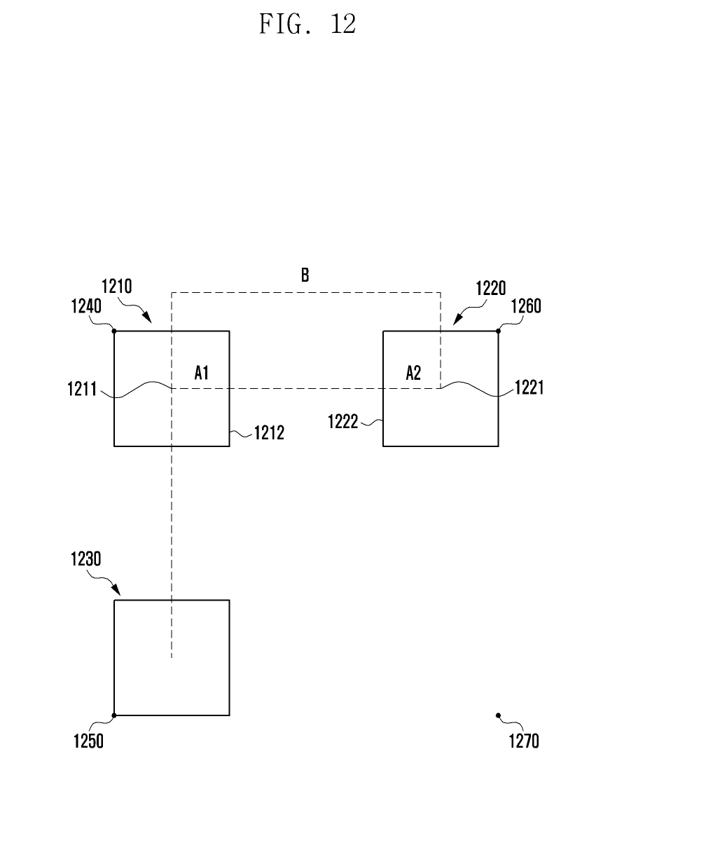

Meanwhile, in operation 550, in order to perform more accurate object localization and restoration, the controller 305 may detect an alignment pattern of the corresponding barcode by using the determined version and size. When the alignment pattern is detected, the controller 305 may object-localize the corresponding barcode at the image based on the alignment pattern. A method of detecting such an alignment pattern will be described in detail with reference to FIGS. 11 and 12.

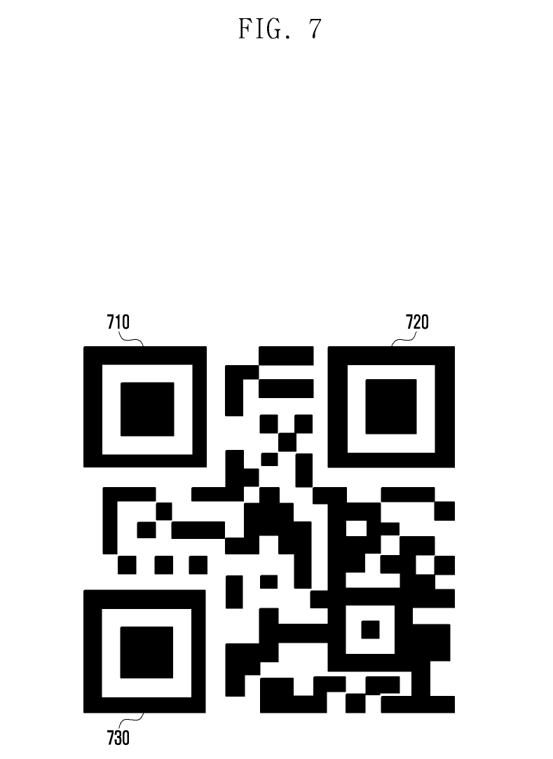

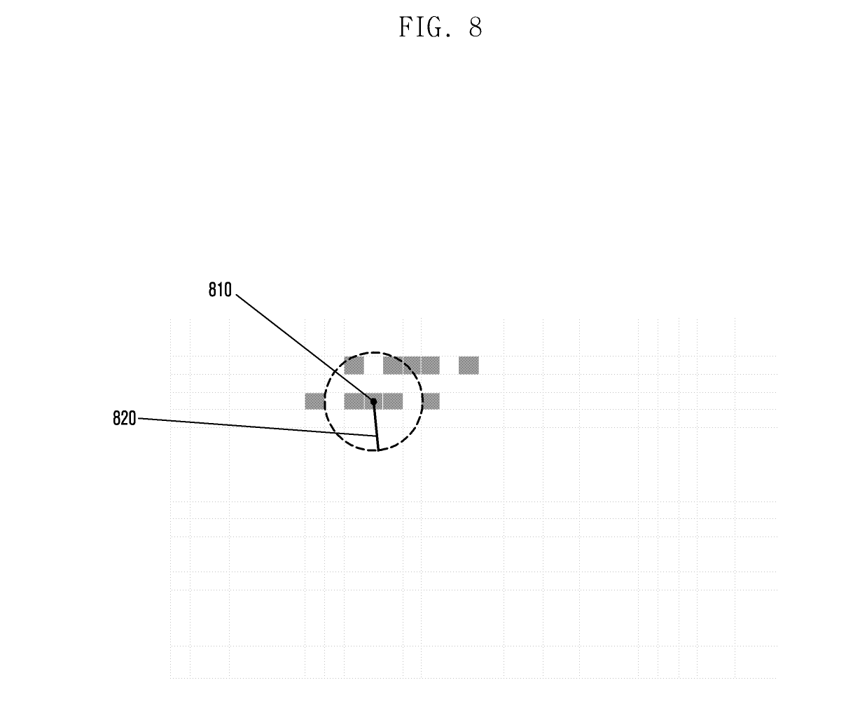

FIG. 6 is a flowchart illustrating a method of detecting a candidate of a finder pattern according to an embodiment of the present disclosure. FIG. 7 illustrates an example of a Quick Response (QR) code. FIG. 8 illustrates a binarized image of a candidate which is detected during a scanning process.

Referring to FIG. 6, in operation 610, the controller 305 may horizontally scan a first line of an image. Here, the scanning may be performed in a pixel unit. For example, when resolution of a screen is 640 (the number of horizontal pixels)*480 (the number of vertical pixels), coordinates of X axis are (0, 640), and coordinates of Y axis are (0, 480). If so, the scanning is performed in a horizontal direction (in a direction of X axis) by a total of 480 times.

In operation 620, the controller 305 determines whether a candidate C_current of a finder pattern is detected in the scanned line. For example, the image may include a QR code. Referring to FIG. 7, a QR code includes three finder patterns 710, 720, and 730. The first finder pattern 710 is located at an upper-left corner, the second finder pattern 720 is located at an upper-right corner, and the third finder pattern 730 is located at a lower-left corner. Referring to FIG. 8, the controller 305 may detect a sequential pattern, in which a black rectangle, a white rectangle, a black rectangle, a white rectangle, a black rectangle, etc. are sequentially disposed, in the scanned line. When a ratio of a black rectangle's width:a white rectangle's width:a black rectangle's width:a white rectangle's width:a black rectangle's width, in such a sequential pattern, is a ratio of 1:1:3:1:1, the controller 305 determines the corresponding pattern as a candidate C_current. Here, a unit of the width may be a pixel.

When the candidate C_current is detected, the controller 305 checks the image in a vertical direction and in a diagonal direction, in operation 630. That is, the controller 305 may scan the image in a vertical direction based on a center point (x, y coordinates) of the corresponding pattern. Further, the controller 305 may scan the image in a diagonal direction (e.g. in a direction of 45 degrees) based on the center point of the corresponding pattern. When the candidate C_current is not detected, the process proceeds to operation 690.

After the checking is completed, in operation 640, the controller 305 determines whether the ratio is maintained. That is, when the image is scanned in a vertical direction and a pattern having a ratio equal to that of the candidate C_current is then detected, the controller 305 determines that the ratio is maintained. Further, when the image is scanned in a diagonal direction and a pattern having a ratio equal to that of the candidate C_current is then detected, the controller 305 determines that the ratio is maintained. Further, when a pattern of which ratios of a diagonal direction and a vertical direction are equal to each other is detected, the controller 305 determines that the ratio is maintained.

When the ratio is maintained within an error range selected by the controller 305, the process proceeds to operation 650. In operation 650, the controller 305 determines whether there is a previous candidate C_previous adjacent to the current candidate C_current. Here, referring to FIG. 8, a condition of the adjacency is whether there is a pattern having the same ratio within a distance 820 selected by the controller 305 from the center point 810 of the candidate C_current.

When there is no adjacent previous candidate C_previous, the process proceeds to operation 660. That there is no adjacent candidate implies that the controller 305 detects a new candidate. Thus, in operation 660, the controller 305 newly adds location information of the candidate C_current to a list. The location information may include coordinates of the center point, and a width (a length of X axis) and a height (a length of Y axis) of the candidate C_current obtained based on the coordinates of the center point. The location information is not limited to the above-mentioned embodiment. As another example, the location information may include the coordinate of the center point and coordinates indicating boundaries of the corresponding candidate. After adding the candidate to the list, the process proceeds to operation 690.

When there is an adjacent previous candidate C_previous, the process proceeds to operation 670. That there is an adjacent candidate implies that the controller 305 detects an existing candidate again. Thus, in operation 670, the controller 305 updates the location information of the previous candidate C_previous. For example, the controller 305 may calculate average values of the coordinates of the center point of the previous candidate and the coordinates of the center point of the current candidate, and update the average values as coordinates of the center point of the previous candidate. Further, the controller 305 may calculate an average value of the width of the previous candidate and the width of the current candidate, and update the average value as the width of the previous candidate. Further, the controller 305 may calculate an average value of the height of the previous candidate and the height of the current candidate, and update the average value as the height of the previous candidate. After updating the candidate, the process proceeds to operation 690.

Meanwhile, when the ratio is not maintained, the process proceeds to operation 680. In operation 680, the controller 305 discards the candidate detected in operation 620. After discarding the candidate, the process proceeds to operation 690.

In operation 690, the controller 305 determines whether there is a remaining line which is not scanned. When there is the remaining line, the controller 305 scans a next line, in operation 695. After scanning the next line, the process returns to operation 620. When there is no remaining line, that is, when the image is completely scanned, the process for detecting the candidate terminates.

In the above example, the pixel is just a unit for scanning, and does not limit the technical spirit of the present disclosure. For example, the scanning may be performed in a block unit. Here, the block may be a region indicating one bit in the corresponding barcode. Further, in the above example, although the detection target is exemplified as the QR code, the present disclosure is not limited thereto. That is, the detection target may be other square barcodes having a finder pattern in addition to the QR code. Further, in the above example, although it is exemplified that the sequential pattern sequentially has a black rectangle, a white rectangle, a black rectangle, a white rectangle, and a black rectangle, and the ratio thereof is 1:1:3:1:1, the present disclosure is not limited thereto. That is, the sequential pattern and the ratio thereof may be changed based on which barcode corresponds to the detection target.

FIG. 9 is a flowchart illustrating a method of determining a finder pattern among the detected candidates according to an embodiment of the present disclosure. FIG. 10 illustrates an example of a contour of a finder pattern according to an embodiment of the present disclosure.

Referring to FIG. 9, in operation 910, the controller 305 may select three candidates among the detected candidates. However, the present disclosure is not limited to the number 3 and more or less candidates may be selected. That is, the number of selected candidates may be determined based on which barcode corresponds to the detection target. In the following description, the detection target is a QR code, and accordingly, the number of selected candidates is assumed to be 3.

In operation 920, the controller 305 identifies a distance between the center points of the selected candidates.

Referring to FIG. 10, a first candidate 1010, a second candidate 1020, and a third candidate 1030 may be selected among candidates. The controller 305 calculates a first length of a first line segment 1040 connecting a first center point 1011 and a second center point 1021. The controller 305 calculates a second length of a second line segment 1050 connecting the second center point 1021 and a third center point 1031. Here, a unit of the length is a pixel, a block, etc.

In operation 930, the controller 305 determines whether a ratio L (obtained by dividing the first length by the second length or dividing the second length by the first length) is less than a threshold selected by the controller 305. Here, a smaller one of the first length and the second length may become a denominator. If so, the ratio L is equal to or larger than 1. Here, when a viewing angle of the camera is ideally a right angle (90 degrees) with respect to a subject (i.e. a barcode), the ratio L may be 1. As the viewing angle of the camera is inclined with respect to the subject, the ratio L may become larger and larger. When the viewing angle of the camera is less than, for example, 60 degrees, the ratio L may exceed a threshold value. If so, recognition of the corresponding barcode may be impossible.

When the ratio L is less than a threshold value, in operation 940, the controller 305 determines whether the candidates are parallel to each other within an error range selected by the controller 305. In detail, referring to FIG. 10, the controller 305 may determine whether a side a1 of the first candidate 1010, a side b1 of the second candidate 1020, and a side c1 of the third candidate 1030 are parallel to each other within an error range selected by the controller 305. When the sides a1, b1, and c1 are parallel to each other (condition 1), the process may proceed to operation 950. Further, the controller 305 may determine whether a side a2 of the first candidate 1010, a side b2 of the second candidate 1020, and a side c2 of the third candidate 1030 are parallel to each other within an error range selected by the controller 305. When the sides a2, b2, and c2 are parallel to each other (condition 2), the process may proceed to operation 950. This process can also be performed by determining whether sides a4, b4 and c4 are parallel to each other. Here, the sides a2, b2, and c2 share the same vertexes with the sides a1, b1, and c1, respectively. Further, the controller 305 may determine whether a line segment 1060 connecting the sides a1 and b1, the line segment 1040, and a line segment 1070 connecting the sides a3 and b3 are parallel to each other within an error range selected by the controller 305. When the line segments 1040, 1060, and 1070 are parallel to each other (condition 3), the process may proceed to operation 950. Here, the sides a3 and b3 face the sides a1 and b1, respectively. Further, the controller 305 may determine whether a line segment 1080 connecting the sides b2 and c2, the line segment 1050, and a line segment 1090 connecting the sides b4 and c4 are parallel to each other within an error range selected by the controller 305. When the line segments 1050, 1080, and 1090 are parallel to each other (condition 4), the process may proceed to operation 950.

When the candidates are parallel to each other within an error range selected by the controller 305 (e.g. when at least one of the conditions 1, 2, 3, and 4 is satisfied), the controller 305 may determine the three selected candidates as the finder patterns of the corresponding barcodes, in operation 950.

Meanwhile, when the ratio L is not less than the threshold value (i.e. when the ratio L is equal to or larger than the threshold value), the process proceeds to operation 960. Further, when the candidates are not parallel to each other within an error range selected by the controller 305 (e.g. when all the conditions 1, 2, 3, and 4 are not satisfied), the process proceeds to operation 960.

In operation 960, the controller 305 determines whether there remain cases where three candidates may be selected among the detected candidates. For example, when the detected candidates are four candidates A, B, C, and D, the cases where three candidates can be selected are four cases including ABC, ABD, ACD, and BCD. When there remain other cases, the controller 305 selects three candidates again (e.g. when the candidates A, B, and C are previously selected, the candidates A, B, and D may be reselected), in operation 970. After reselecting the candidates, the process returns to operation 920. When there remains no case, the controller 305 may determine that the recognition of the barcode in the image fails, in operation 980. In this way, when it is determined that the recognition of the barcode fails, the controller 305 may provide a message indicating that it is impossible to recognize the barcode, to a user. Such a message may be provided by an acoustic feedback (e.g. a sound output through a speaker), a visual feedback (e.g. a message displayed on a screen), a tactile feedback (e.g. vibration of a motor) and the like. A user who has received such a feedback may adjust a shooting angle such that the terminal 300 can recognize the barcode.

Meanwhile, a larger one of the first length and the second length may become a denominator. If so, the ratio L is equal to or less than 1. Accordingly, in contrast to the above example, operation 930 may be a process of determining whether the ratio L is greater than the threshold value selected by the controller 305. That is, when L is greater than the threshold value, the process may proceed to operation 940, and when L is less than the threshold value, the process may proceed to operation 960.

Further, in the above example, although it is exemplified that the ratio is a value indicating a difference between the two values, the present disclosure is not limited thereto. For example, when there is a value A indicating a distance between the first finder pattern and the second finder pattern, a value B indicating a distance between the second finder pattern and the third finder pattern, and a value C indicating a distance between the first finder pattern and the third finder pattern, a ratio thereof may be A:B:C.

FIG. 11 is a flowchart illustrating a method of determining a finder pattern among the detected candidates according to another embodiment of the present disclosure.

Referring to FIG. 11, the controller 305 may select three candidates among the detected candidates, in operation 1110, then proceed to operation 1120 to identify distances between the center points of the selected candidates, then proceed to operation 1130 to determine whether the ratio L is less than the threshold value selected by the controller 305, and then when it is determined that the ratio L is less than the threshold value, proceed to operation 1140 to determine the three selected candidates as the finder patterns of the corresponding barcode. A difference point between the embodiment of FIG. 9 and the embodiment of FIG. 11 is that operation 940 may be omitted.

Meanwhile, when the ratio is greater than the threshold value, in operation 1150, the controller 305 determines whether there remain cases where three candidates may be selected among the detected candidates. When there remain other cases, the controller 305 selects one case among the remaining cases again, in operation 1160. After reselecting the candidates, the process returns to operation 1120. When there remains no case, the controller 305 may determine that the recognition of the barcode in the image fails, in operation 1170.

FIG. 12 is a view for describing an example of a process of calculating a version of a barcode based on a finder pattern. Equation (1) is an equation which may be used for calculating a version of a barcode.

$$Version = ( \frac{7 \cdot ( {A}_{1} + {A}_{2} + B )}{4 \cdot ( {A}_{1} + {A}_{2} )} - 17 ) \div 4 \qquad Equation ( 1 )$$

Referring to FIG. 12, in Equation (1), A₁ is a value indicating a length from a first center point 1211 of a first finder pattern 1210 to a side 1212 of the first finder pattern 1210. A₂ is a value indicating a length from a second center point 1221 of a second finder pattern to a side 1222 of the second finder pattern 1220. B is a value indicating a length of a line segment connecting the first center point 1211 and the second center point 1221.

The controller 305 calculates the version of the barcode by using Equation (1) and accesses a lookup table, so as to identify size information of the barcode corresponding to the calculated version. Here, the lookup table is a table having size information corresponding to each version, and may be stored in the memory 340 of the terminal 300. When the barcode (e.g. a QR code) is square, the size information may include a value indicating a length of a side. Further, the size information may include various information informing of a size of the corresponding barcode, in addition to the value indicating a length of a side.

Referring back to FIG. 12, the controller 305 may identify three vertex coordinates 1240, 1250, and 1260 among the vertex coordinates of the corresponding barcode through location information of the finder patterns 1210, 1220, and 1230. Thus, when the size information of the corresponding barcode is identified, the controller 305 may calculate remaining vertex coordinates 1270 based on the three already-known vertex coordinates 1240, 1250, and 1260 and the identified size information. Further, the controller 305 may object-localize the corresponding barcode at the image by using the vertex coordinates 1240, 1250, 1260, and 1270. Thereafter, the controller 305 may warp the barcode in which the object localization is performed. Such a warping process may include a process of calibrating the coordinate values of the corresponding barcode. Such a calibration process refers to homography calculation. The controller 305 may extract data from the barcode processed through warping. Further, the controller 305 may perform a function (e.g. web-site connection) corresponding to the extracted data.

Meanwhile, the controller 305 may perform more accurate object localization of the corresponding barcode based on an alignment pattern. To this end, the controller 305 may detect the alignment pattern.

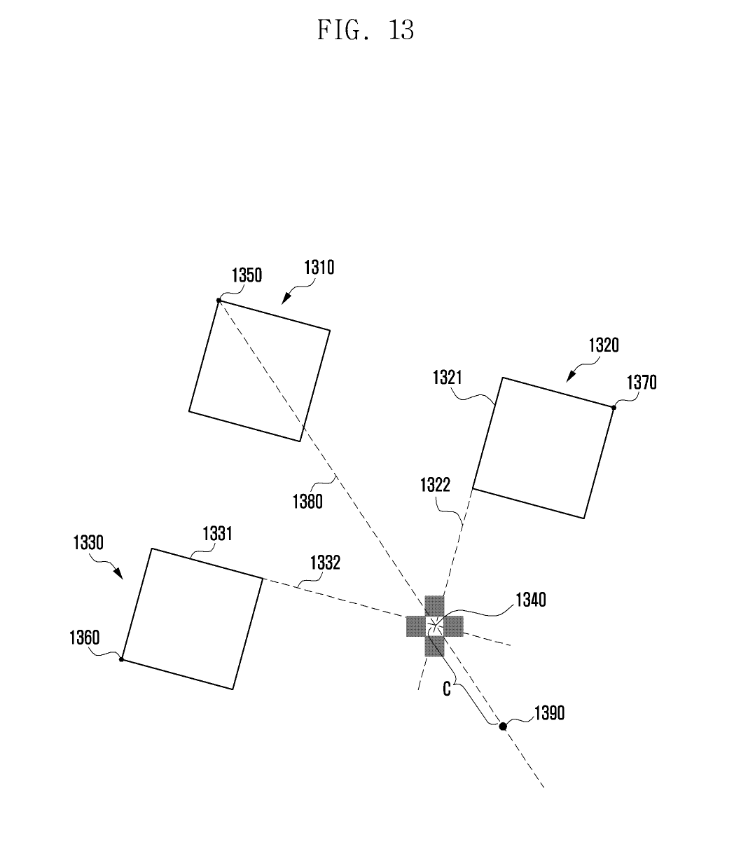

FIG. 13 is a view for describing an example of a process of detecting an alignment pattern based on a finder pattern according to an embodiment of the present disclosure.

Referring to FIG. 13, in a state where finder patterns 1310, 1320, and 1330 are detected and vertexes 1350, 1360, and 1370 of the corresponding barcode are identified through the detected finder patterns 1310, 1320, and 1330, the controller 305 calculates a line segment 1322 extending from a side 1321 of the second finder pattern 1320. Further, the controller 305 calculates a line segment 1332 extending from a side 1331 of the third finder pattern 1330. Thereafter, the controller 30 calculates coordinates of a point 1340 where the line segments 1322 and 1332 intersect with each other.

The controller 305 identifies whether black patterns are located at upper/lower/left/right sides with respect to the intersecting point 1340, respectively. When it is identified that the black patterns are located, the controller 305 identifies a horizontal ratio and a vertical ratio. When the horizontal ratio is 1 (black):1 (white):1 (black) and the vertical ratio is 1 (black):1 (white):1 (black), the controller 305 determines the black patterns as the alignment pattern. Further, the controller 305 determines the intersecting point 1340 as a center point of the alignment pattern.

When the center point 1340 of the alignment pattern is determined, the controller 305 calculates a line segment 1380 extending from the first vertex 1350 of the corresponding barcode and passing through the center point 1340 of the alignment pattern. Thereafter, the controller 305 determines coordinates 1390 of the line segment 1380, located apart from the center point 1340 by a distance C, as vertex coordinates of the corresponding barcode. Here, the distance C may be a value selected by the controller 305 with reference to the size information of the corresponding barcode. For example, when the corresponding barcode is a QR code, the distance C may be 6.5 blocks. In this way, when the vertex coordinates 1390 are determined, the controller 305 may object-localize the corresponding barcode at the image by using the vertex coordinates 1350, 1360, 1370, and 1390. Thereafter, the controller 305 may warp the barcode in which the object localization is performed. The controller 305 may extract data from the barcode processed through warping. Further, the controller 305 may perform a function (e.g. web-site connection) corresponding to the extracted data.

The method according to the present disclosure as described above may be implemented by a program command which may be performed through various computers and may be recorded in a computer-readable recording medium. Here, the recording medium may include a program command, a data file, a data structure, etc. Further, the program command may be especially designed and configured for the present disclosure, or may become known to those skilled in the art of the computer software to be used. Further, the recording medium may include a magnetic media such as a hard disk, a floppy disk, and a magnetic tape, an optical media such a Compact Disc Read-Only Memory (CD-ROM) and a Digital Video Disc (DVD), a magneto-optical media such as a floptical disk, and a hardware device such as a Read-Only Memory (ROM), a Random Access Memory (RAM), a flash memory, etc. Further, the program command may include a high level language code executed by a computer by using an interpreter as well as a machine language code made by a compiler. The hardware device may be configured to operate as one or more software units in order to perform the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
detecting finder pattern candidates;
extracting contour information of the finder pattern candidates;
determining one or more finder patterns of a barcode in a digital image among the finder pattern candidates based on at least a piece of the contour information; and
detecting an alignment pattern based on at least a part of the one or more finder patterns and the contour information.

2. The method of claim 1, wherein a distorted image of the barcode is warped to a frontally-viewed image based on the one or more finder patterns and the alignment pattern.

3. The method of claim 1, wherein the barcode comprises a QR code.

4. The method of claim 1, further comprising determining one or more of a version or a size of the barcode based on at least a part of the one or more finder patterns.

5. The method of claim 1, wherein the contour information comprises outermost contours of the finder pattern candidates.

6. The method of claim 1, wherein the extracting of the contour information comprises extracting a contour from a region enclosing one of the finder pattern candidates.

7. The method of claim 1, wherein the determining of the one or more finder patterns comprises:
determining whether sides corresponding to contours of a pair of the finder pattern candidates selected among the finder pattern candidates are parallel to each other;
determining whether the contours is parallel to lines connecting center points of the finder pattern candidates; and
determining whether a ratio between lengths of the lines connecting the center points of the one or more finder patterns is equal to or less than a selected value.

8. The method of claim 1, further comprising:
identifying distances between the finder pattern candidates selected among the finder pattern candidates by a number determined by the electronic device; and
determining whether a ratio indicating a difference between the distances satisfies a condition selected by the electronic device.

9. The method of claim 8, further comprising, when the ratio satisfies the selected condition, determining the selected candidates as a finder pattern of the corresponding barcode.

10. The method of claim 8, wherein the determining of whether the ratio satisfies the selected condition comprises determining whether a ratio of a first length and a second length is greater than a value selected by the electronic device or less than a value selected by the electronic device,
wherein the first length is a value indicating a distance between a center point of a first candidate and a center point of a second candidate, and the second length is a value indicating a distance between the center point of the second candidate and a center point of a third candidate.

11. The method of claim 10, wherein the determining of whether the ratio satisfies the selected condition comprises determining whether the selected candidates are parallel to each other when the ratio of the first length and the second length is greater than the value selected by the electronic device or less than the value selected by the electronic device.

12. The method of claim 11, wherein the determining of whether the candidates are parallel to each other comprises at least one of:
determining whether a side of one of the selected candidates is parallel to a side of another one of the selected candidates; and
determining whether a line segment connecting a center point of one of the selected candidates and a center point of another one of the selected candidates is parallel to a side of one of the candidates.

13. The method of claim 8, further comprising:
when the ratio does not satisfy the selected condition, reselecting candidates among the detected candidates by the number determined by the electronic device; and
determining whether a ratio indicating a difference between distances between the reselected candidates satisfies a condition selected by the electronic device.

14. A method of operating an electronic device, the method comprising:
selecting three finder pattern candidates among finder pattern candidates to determine a finder pattern of a QR code in a digital image;
identifying a first length indicating a distance between a first candidate and a second candidate among the selected finder pattern candidates, and a second length indicating a distance between the second candidate and a third candidate; and
determining whether a ratio of the first length and the second length is less than a value selected by the electronic device.

15. The method of claim 14, further comprising, when the ratio is less than the selected value, determining the selected finder pattern candidates as finder patterns of the QR code.

16. The method of claim 14, further comprising:
when the ratio is less than the selected value, determining whether the selected finder pattern candidates are parallel to each other; and
when the selected finder pattern candidates are parallel to each other, determining the selected finder pattern candidates as finder patterns of the QR code.

17. The method of claim 16, further comprising:
when the ratio is greater than the selected value, determining whether three other finder pattern candidates remain which are selected among the finder pattern candidates; and
when the three other pattern candidates remain, reselecting the three other finder pattern candidates.

18. The method of claim 16, further comprising:
when the selected finder pattern candidates are not parallel to each other, determining whether three other finder pattern candidates remain which are selected among the finder pattern candidates; and
when the three other finder pattern candidates remain, reselecting the three other finder pattern candidates.

19. An electronic device comprising:
a memory that stores a digital image; and
a processor that processes the digital image,
wherein the processor detects finder pattern candidates;
extracts contour information of the finder pattern candidates;
determines one or more finder patterns of a barcode in the digital image among the finder pattern candidates based on at least a piece of the contour information; and
detects an alignment pattern based on at least a part of the one or more finder patterns and the contour information.

20. An electronic device comprising:
a memory that stores a digital image; and
a processor that processes the digital image,
wherein the processor selects three finder pattern candidates among finder pattern candidates;
identifies a first length indicating a distance between a first candidate and a second candidate among the selected finder pattern candidates, and a second length indicating a distance between the second candidate and a third candidate; and
determines whether a ratio of the first length and the second length is less than a value selected by the electronic device.
